(19) United States
(12) Patent Application Publication
(10) Pub. No.: US 2013/0308817 A1
(43) Pub. Date: Nov. 21, 2013

(54) MANAGEMENT OF DIGITAL INFORMATION USING AN INDIVIDUAL DIGITAL WATERMARK

(71) Applicants: Fred Edward Konkel, Oakland, CA (US); Randi Sharon Rose Lee, Oakland, CA (US); Robert Joseph Dow, Oakland, CA (US)

(72) Inventors: Fred Edward Konkel, Oakland, CA (US); Randi Sharon Rose Lee, Oakland, CA (US); Robert Joseph Dow, Oakland, CA (US)

(21) Appl. No.: 13/563,734

(22) Filed: Aug. 1, 2012

Related U.S. Application Data
(60) Provisional application No. 61/574,355, filed on Aug. 1, 2011.

(51) Int. Cl. G06T 1/00

(52) U.S. Cl. CPC G06T 1/0021
USPC 382/100

(57) ABSTRACT

The present invention provides, in at least one embodiment, a system and method for management of digital information using an individual digital watermark. The system facilitates and controls engagements between an individual and other individuals or businesses. The system uses processing software to register an individual. The system stores an individual's profile and preference information in a database of digital information. When the individual makes contact with another entity (e.g., business or another individual) that he would like to connect with or share information with from his database, the individual allows his device to be scanned using a scanner (e.g., microphone or camera) such that the other entity can extract the embedded individual digital watermark and unlock access to a category of the individual's database of preselected digital information.

### CROSS REFERENCE TO RELATED APPLICATIONS

This application claims priority under 35 U.S.C. §119(e) to U.S. Provisional Application No. 61/574,355, filed Aug. 1, 2011, and entitled “System for using an individual digital watermark as a unique identifier to provide individuals and businesses with control over their digital identities and engagements,” the disclosure of which is hereby incorporated by reference in its entirety.

### BACKGROUND OF THE INVENTION

1. Field of Invention

The invention relates generally to digital information management and more particularly, to a method and system for managing and exchanging digital information via digital watermarks.

2. Description of Related Art

Digital watermarking is the process of embedding information into a digital signal by making slight modifications to the underlying media. For example, a digital watermark is a pattern of bits embedded into a digital image file, audio file, or video file. For images and video, the digital watermarks can be embedded within pixels. For audio and video sound tracks, the digital watermarks can be embedded as background noise. The digital watermark, i.e., the pattern of bits, may carry any type of useful information such as a unique identifier. Typically, digital watermarks are permanently embedded in the underlying media and are difficult to remove. When the underlying media is copied, the digital watermark is copied as well.

Digital watermarks may be visible or invisible to a human's eye. Typically, the visible digital watermark is text or a logo which identifies the owner of the media. For example, a visible digital watermark includes the logo in the corner of a television broadcast. On the other hand, an invisible digital watermark is generally imperceptible to humans and can only be discerned by machine, e.g., computer software. Similar to visible digital marks, invisible digital watermarks are information added to the digital data and can contain ownership or other descriptive information.

Digital watermarks provide information which may be used to verify the authenticity of media or the identity of its owners. The digital watermark can link to another source of information or act as a means of initiating communication between individuals. Digital watermarks act in the same manner as a paper bearing a watermark for visible identification.

Digital watermarking is used in many applications such as forgery protection, audience tracking, date integrity management, identity verification, authentication, security, and deterring unauthorized copying of digital media. As an example, some media copying devices are equipped with the ability to retrieve the digital watermark before making a copy, such that the copying device can check the digital watermark before deciding whether or not to make a copy of the digital media. In another example, a source tracing device enables an owner of digital media who finds an illegally copied movie to trace back within the digital signal to see who made the illegal copies, because a watermark is embedded into the digital signal at each point of distribution.

A process of reading digital watermarks from display screens is described in U.S. Pat. Pub. No. 2007/0183,623 and U.S. Pat. No. 7,123,740, where the technical details of watermarking technology is described in U.S. Pat. Nos. 6,614,914 and 6,947,571, all of which are assigned to Digimarc Corporation and are incorporated herein by reference. The implementation of digital watermarks is readily apparent to one of ordinary skill in the art.

Social media has taken off recently. Social media network websites include sites like Twitter, Bebo, MySpace, LinkedIn, YouTube, Google+, and Facebook. More broadly, social media includes web-based and mobile based technologies which are used to turn communication into interactive dialogue among organizations, communities, and individuals.

The problem with social media is the difficulty of managing and sharing digital information such as files, photos, contact information, and invitations. There are existing software applications (or “apps”) that help individuals manage their identities and engagements, however each falls short when it comes to allowing people to control their digital identities and share digital engagements in an efficient and user friendly manner. For example, Bump is a mobile app (for iPhone or Android enabled devices) that allows two users to share contact information and photos, connect on social networking websites, and sync devices by opening their bump mobile apps and simply “bumping” their two phones together. However, Bump requires a network connection, is another information silo structure as opposed to conduit for transferring information which does not need to be separately updated, and Bump has a challenging user interface.

Foursquare is a location-based social networking application for mobile devices that allows users to “check in” at venues using a mobile website, text messaging, or a device-specific application by selecting from a list of venues the application locates nearby using GPS.

About.me is a personal web hosting service which links multiple online identities, relevant external sites, and popular social networking websites such as Twitter, Facebook, LinkedIn, Flickr, YouTube, Tumblr. About.me is characterized by its one-page user profiles, each with a large, often-artistic background image and abbreviated biography.

Katango, owned by Google, develops social algorithms that improve people's online social interaction. Katango's mission is to restore simplicity to your social life by taming the tsunami caused by the social network era.

HootSuite is a social media management system for brand management. The system's user interface takes the form of a dashboard, and supports social network integrations.

However, each of these social data management tools fall short because they do not allow users to initiate a connection with others when no network access is available, they do not automatically manage interactions as a conduit of information, they do not simultaneously share preselected categorized bundles of information with one engagement, and they do not unlock digital information using an individual digital watermark as a unique identifier.

### SUMMARY OF THE INVENTION

The present invention provides, in at least one embodiment, a system and method for management of digital information using a unique digital watermark assigned to each user. The system facilitates and controls engagements between an individual and other individuals or businesses. The system uses processing software to register an individual. The system stores an individual's profile and preference information in a database of digital information. When the individual makes contact with another entity (e.g., business or another individual) that he would like to connect with or share information with, one individual allows his device to be scanned using a scanner (e.g., microphone or camera in a iPhone or the like) such that the scanning entity can extract the embedded individual digital watermark and initiate a connection between the devices. This connection makes it possible for an individual to provide access to a category or other elements of their database of preselected digital information.

An advantage of the present invention is that the connection can be made without network access (i.e., offline, without cell coverage). For example, even if the mobile devices are offline, the users can scan a wallpaper image with an app that facilitates a digital interaction between the two users. While offline, the individual can still access an app of the system to scan another's individual digital watermark before determining which information to share. When an online connection is made, the individuals can share a preselected default bundle of information (e.g., information customized by category) with one click, navigate to other bundles of information and share those, or choose specific elements to share.

Another advantage is that many of the right pieces of information can simultaneously be shared with the right person or business in one engagement. This is made possible by the information being preselected into categories ahead of time, such that the user can quickly and simply share information when or after they meet another individual or business. Different categories of digital information may be ideal for different people. For example, a friend may receive access to photos, a colleague access to LinkedIn, a retail business or a service business can provide access to their particular digital information. The digital information shared includes, but is not limited to, links, files, photos, contact information, favorites, music, coupons, social networks, affinity programs, games, etc.

Further, since the system is a conduit for transferring digital information, as opposed to a separate data silo for creating or hosting digital information, the system is designed to accommodate the growth and evolution of the digital information over time. Additionally, the system requires approval before information can be shared, such that the digital information is not automatically transferred upon scanning the individual digital watermark.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a digital information management system according to an embodiment of the invention;

FIG. 2 illustrates an user interface of the digital information management system according to an embodiment of the invention;

FIGS. 3-8 illustrate two individuals sharing digital information according to embodiments of the invention;

FIGS. 9-12 illustrate a business sharing digital information with one or more individuals according to embodiments of the invention; and

FIG. 13 illustrates the process of associating two individuals according to an embodiment of the invention.

### DETAILED DESCRIPTION OF EMBODIMENTS

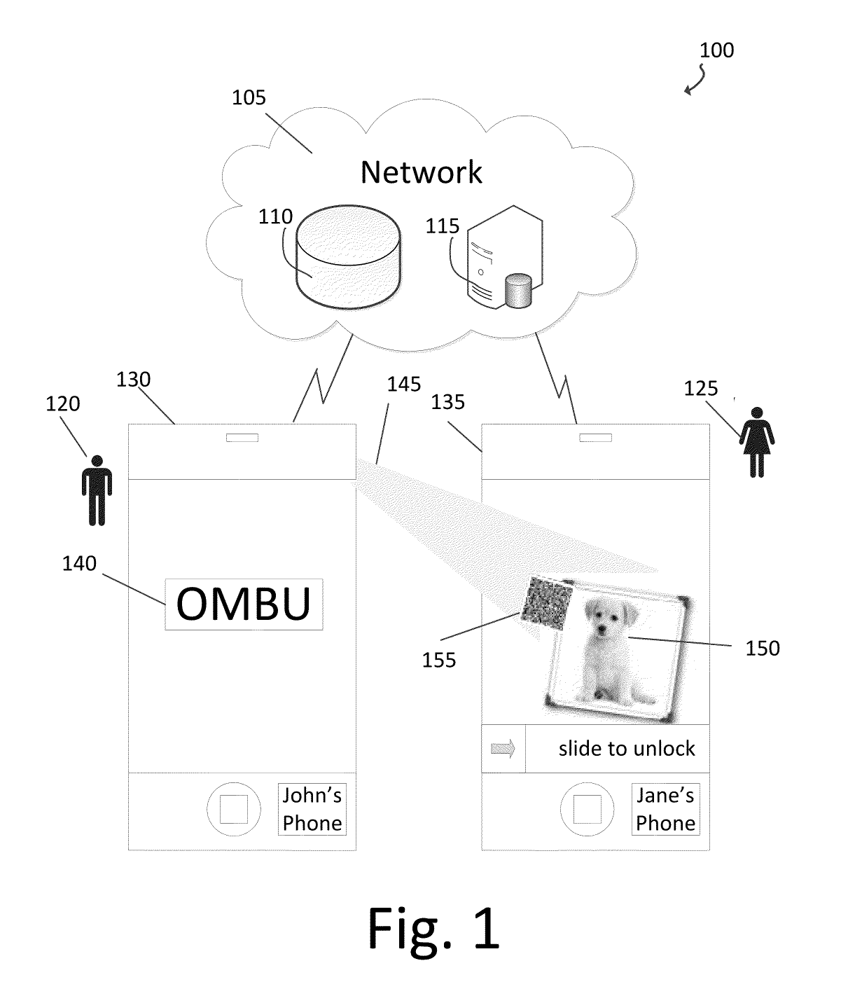

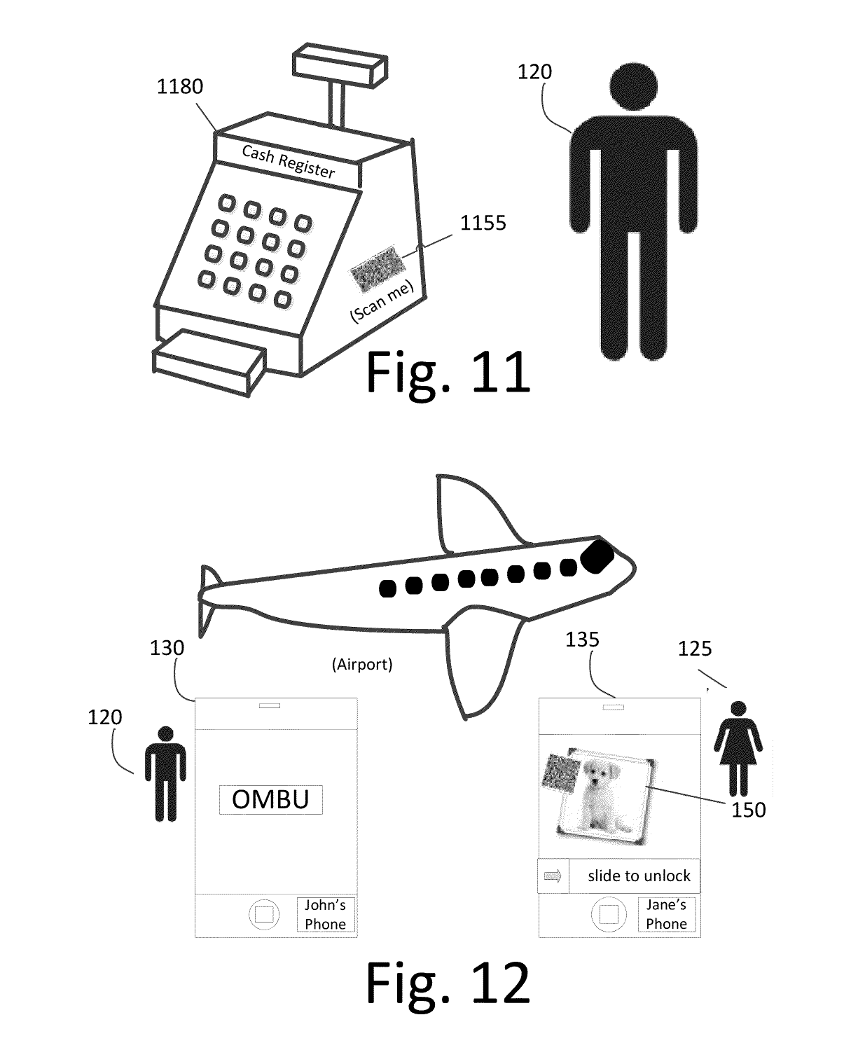

Further features and advantages of the invention, as well as the structure and operation of various embodiments of the invention, are described in detail below with reference to the accompanying FIGS. 1-13, wherein like reference numerals refer to like elements. Although the invention is described in the context of digital watermarks for images, other types of communications media may be used such as, but not limited to audio and video.

The present invention provides, in at least one embodiment, a system and method having a mobile application designed to enable a device to device (e.g., smartphone to smartphone) sharing of one or more categories of pre-selected digital information via a communications media, e.g., image. For example, a first mobile device acquires a sample of an image displayed on a second mobile device. The sample is then processed by software (either locally on an app or remotely on a server) to identify the digital watermark and the watermark information contained therein. The watermark information is then used to identify (from a server) a digital identity of the user associated with the second mobile device and open a conduit for sharing information.

Sharing information from computer to computer is relatively easy compared to exchanging digital information in person between mobile devices. In the time that it takes to send a text or email, the system lets an individual simultaneously provide his contact information, files, photos, play lists, social networks, and/or practically any other digital information that he chooses. With the present invention, a simple scan makes it possible to initiate and control digital engagements and the transfer of desired data. The present invention is a convenient, fun, and rewarding platform for making connections and sharing information. The user can manage his preferences from his mobile devices wherever he has network access or from a computer via a website.

FIG. 1 illustrates a digital information management system 100 according to an embodiment of the invention. The system 100 comprises a network 105 having a database 110 and processing software 115, a first entity 120 (e.g., first individual or business) having first device 130, a second entity 125 (e.g., second individual or business) having a second device 135, an app 140, a scanner 145, and an image 150 including an individual digital watermark 155. One of ordinary skill in the art readily appreciates that other types of communications media may be used instead of an image—for example, an audio or video file. The system 100 allows individuals and businesses to manage their digital identities through digital engagements. A digital identity includes all the digital information that an entity would consider sharing, and a digital engagement is a connection between two entities that plan to exchange digital information.

The network 105 (e.g., Ombu network, the Internet, a distribution platform, etc.) provides a way to connect to and transfer digital information between the first entity 120 and the second entity 125, or between the first entity 120 and a business. The information is stored in the database 110, and when the network 105 receives the proper authentication, which is the correct individual digital watermark of a user's database, the network 105 opens a conduit for sharing selected digital information. The first entity 120 can the direct the network 105 to connect to the first entity's information in the database 110 with the second entity 135. The network 105 interacts with the first device 130 during registration and updates the profile and preference information.

The database 110 (e.g., management and interaction database) stores an individual's registration information, preference information, behavior, utilization of their individual digital watermark, provides data for the facilitation and control of engagements between individuals, and other information. The database 110 having the first entity information initially being locked such that the other user cannot access it until the first entity or the second entity can scan the others individual digital watermark and decide to share.

The processing software 115 registers an entity, creates and assigns the entity's unique individual digital watermark stored in the database 110, and embeds the individual digital watermark into an image 150 or audio/video file. The digital watermarks can be created by the processing software 115 or the device 130 itself. The processing software 115 also manages the interaction between the app 140 and the database 110. In one embodiment, the image 150 is the user's existing wallpaper image with a logo indicating the app 140. Using the existing wallpaper makes the registration as smooth as possible because no extra effort is required. In another embodiment of the invention, the processing software 115 returns the embedded image to the individual in a wallpaper ready format, which the individual adds to their mobile device's wallpaper. Alternatively, the embedded image is a photo, which could be stored in the mobile device's memory. The photo may be transmitted via any communications channel such as, but not limited to, an email, a multimedia messaging service (MMS) message, a web page, or printed material.

The first entity 120 (e.g., first individual, John, etc.) is illustrated as a male and the second entity 125 (e.g., second individual, Jane, etc.) is illustrated as a female, although they could be different genders or businesses. Each individual 120, 125 is uniquely assigned to a particular individual digital watermark 155 in a one-to-one relationship.

The first individual's name, John, is illustrated on his device 130. The second individual's name, Jane, is illustrated on her device 135. The first individual 120 and the second individual 125 could meet in a social context or in a business context. If the first individual 120 and the second individual 125 want to connect (e.g., LinkedIn, Facebook, etc.) or share digital information (e.g., exchange contact information, exchange photos, etc.), the system 100 provides a novel way to unlock and subsequently share the digital information.

The first device 130 and the second device 135 can both be smartphones. Alternatively, the devices 130, 135 can be a combination of a mobile device, a tablet, a laptop computer, a desktop computer, a television, or another task-specific device. If both devices 130, 135 are smartphones, both can have application software (e.g., an iPhone app, BlackBerry app, etc.) such that the system 100 manages their information using the apps.

The app 140 (e.g., Ombu app) leverages the network 105 such that individuals and businesses can connect and share information. As is known by one with ordinary skill in the art, an app can operate on both mobile devices and web-based computers. The app 140 is linked to the network 105 for the individuals to register, to embed their unique individual digital watermark, and create/update engagements and preferences. The app 140 allows individuals to facilitate and control engagements with other individuals and businesses.

The scanner 145 allows the first individual 120 to use his device 130 to scan the individual digital watermark 155 of the second individual 125. The scanner 145 extracts the individual digital watermark, also known as key data, which is embedded in the image or audio/video file. The individual digital watermark is relayed to the processing software 115 to verify which database to unlock. The scanner 145 can be a camera or microphone of a smartphone, computer, or other device. The camera extracts the individual digital watermark 155 embedded in the image 150 or a video file. The microphone extracts the individual digital watermark from an audio file or video sound track.

The image 150 (e.g., raster image, wallpaper of mobile device, etc.) can be selected by the second individual 125 during registration. The illustrated image 150 is a puppy. The image 150 can be assigned as the wallpaper on the second individual's smartphone. The wallpaper can be shown when the second individual 125 turns on her device 135. In another embodiment, the image 150 can be the screen of a mobile device, computer, television, monitor, tablet, smartphone, printed media, playing of audio file, or playing of a digital file.

The individual digital watermark 155 (e.g., key data) is embedded in the image 150. The individual digital watermark 155 is an identifier assigned uniquely to the second individual 125. Assigned uniquely means that the second individual has only one identifier, and no one else shares that same identifier. The individual digital watermark 155 is embedded into the digital media and facilitates and controls engagements between individuals. The individual digital watermark 155 is a one to one identity controller that opens up a conduit for sharing certain information in the individual's database 110 to other individuals, based on the individual's preferences.

The individual digital watermark 155 is shown as being visible, which is easier to illustrate in a patent application. A visible individual digital watermark would be helpful for businesses, because it enables individuals to find it more easily.

In another embodiment, the individual digital watermark 155 is invisible. An invisible watermark produces a cleaner looking wallpaper image 150 or audio/video file and allows the second individual 125 to hide the fact that she has an individual digital watermark 155 on her wallpaper. Additional authentication, such as a password or a set of verification questions, can be used to ensure that the individual using the individual digital watermark is the individual to whom the individual digital watermark is registered.

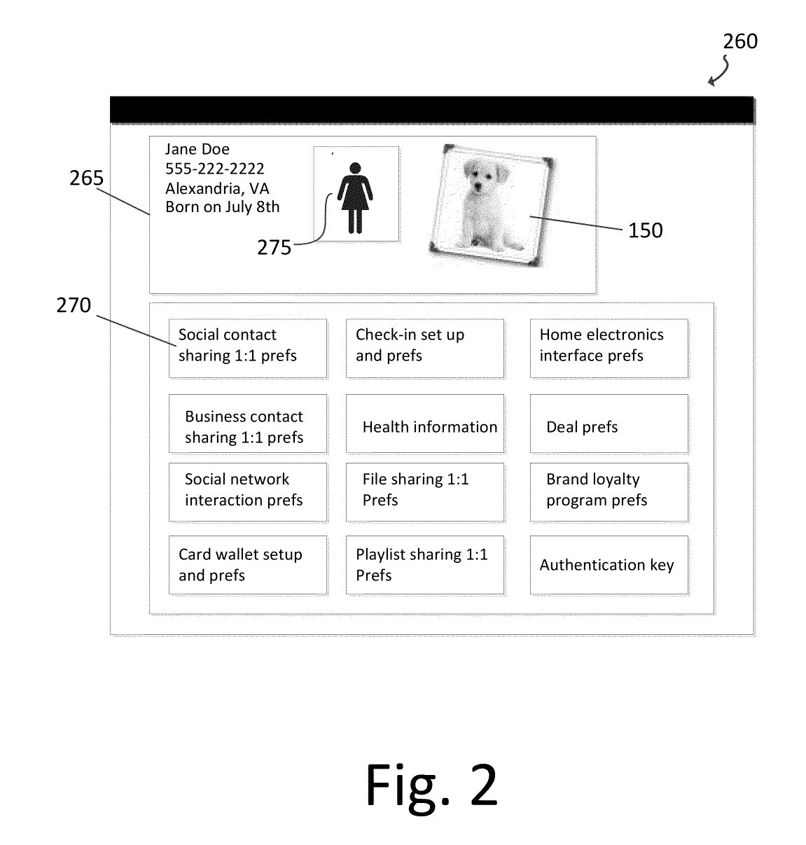

FIG. 2 illustrates a user interface 260 of the digital information management system 100 according to an embodiment of the invention. The user interface 260 can be accessed online or on a mobile device. The user interface 260 allows for the registration of the individual 125 and the updating her profile 265 and preferences 270.

For registration, the individual needs to download the app 140. In one embodiment, both the first individual 120 and the second individual 125 will need the app 140 to connect and exchange information. In another embodiment, only one individual needs the app 140, and that individual can share his information via text or email even if the other person does not have the app 140. This can be done on a mobile device or computer. The registration process prompts for certain identifying information. The registration process includes the individual 125 providing the image 150, which the processing software 115 will embed a unique individual digital watermark 155 into. The individual 125 may also update her profile 265 with her picture 275. This registration information is transmitted by the app 140, processed by the processing software 115, and stored in the database 110, as are subsequent interactions.

The individual is prompted to enter any preferences 270 she may have related to the processing of future engagements. The preferences 270 are preselected categories of digital information that allow later sharing and connecting to be easy. The preferences 270 allow the individual 125 to more efficiently interact with businesses, colleagues, and friends.

Selecting social contacts sharing 1:1 allows the individual 125 to set preferences related to sharing and connecting to her social information (e.g., cell phone number, personal email address, Facebook profile). Selecting business contact sharing 1:1 allows the individual 125 set preferences related to sharing her business information (e.g., business phone number, business email address, LinkedIn profile).

Selecting check-in set up and preferences allows the individual 125 to share her location information and preferences for use of that information. Selecting home electronics interface preferences allows the individual 125 to set preferences and share her DVR or television favorites and play lists. Selecting health information allows the individual 125 to set preferences and share medical history, drug information and allergy information. Selecting deal preferences allows the individual 125 to share her preferences for deals and offers. Selecting social network interaction preferences allows the individual 125 to set up her social network posting and sharing preferences. Selecting file sharing 1:1 preferences allows the individual 125 to set up preferences for sharing files with others.

Selecting brand loyalty program preferences allows the individual 125 to set up and select preferences for engaging with brand loyalty programs. Selecting card wallet setup and preferences allows the individual 125 to set up a card wallet for collecting points, rewards and deals and storing wallet information such as ID cards, credit cards and frequent flyer numbers. Selecting playlist sharing 1:1 preferences allows the individual 125 to set up her preferences for sharing music playlists. Selecting authentication key allows the individual 125 to set up a pin for higher security actions such as mobile payments.

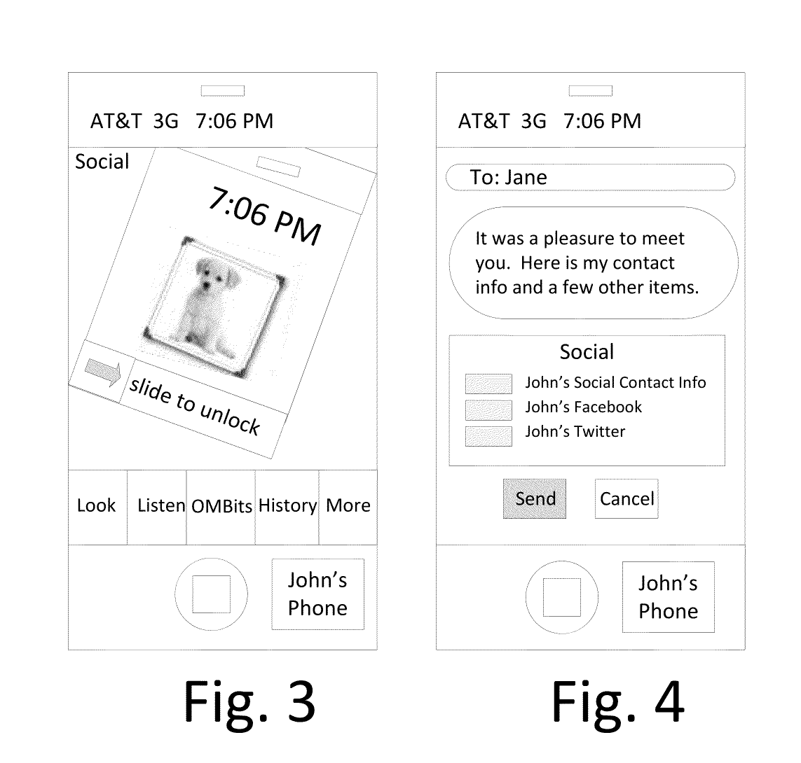

FIGS. 3-8 illustrate two individuals sharing digital information according to embodiments of the invention. In this embodiment, the first individual 120 chooses to share social information and the second individual 125 chooses to share business information. Both individuals 120, 125 have downloaded the app 140 to their devices 130, 135.

As illustrated in FIG. 3, the first individual 120 asks the second individual 125 if she would like his contact information. If the second individual 125 agrees, she allows him to scan her embedded individual digital watermark 155 as illustrated in FIG. 1 and FIG. 3. The first individual 120 scans the second individual's image by opening the downloaded app 140 on his mobile device 130 and focusing his camera on the second individual's wallpaper image 150.

As illustrated in FIG. 4, upon a successful scan his device opens the app 140 to his default sharing preference. The first individual's device may also give an audible notification of this success through his app 140. The first individual 120 then selects “Send” and if his device 130 has internet connectivity, the app 140 immediately transmits a message including the information he has chosen to share to the processing software 115. If the first individual's device 130 is not connected to the Internet, the app 140 stores the message for later processing. Once the first individual's device 130 receives an Internet connection, the message is sent to the processing software 115. The processing software 115 furthers the engagement by sending a notification message to the second individual 125 via SMS, email or other methods according to their preferences stores in their respective database 115.

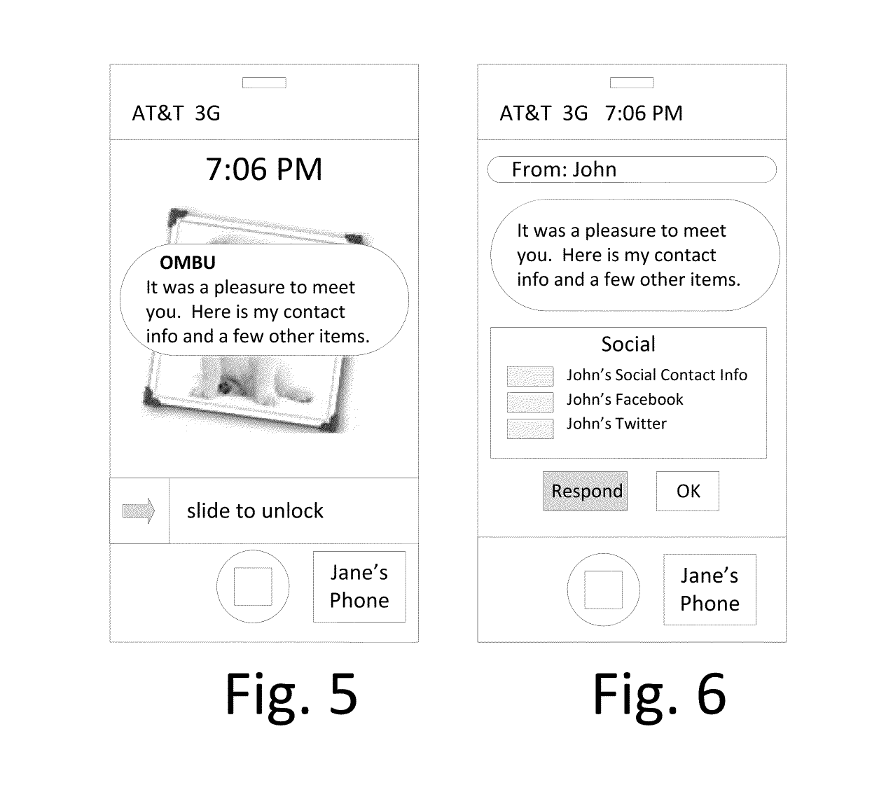

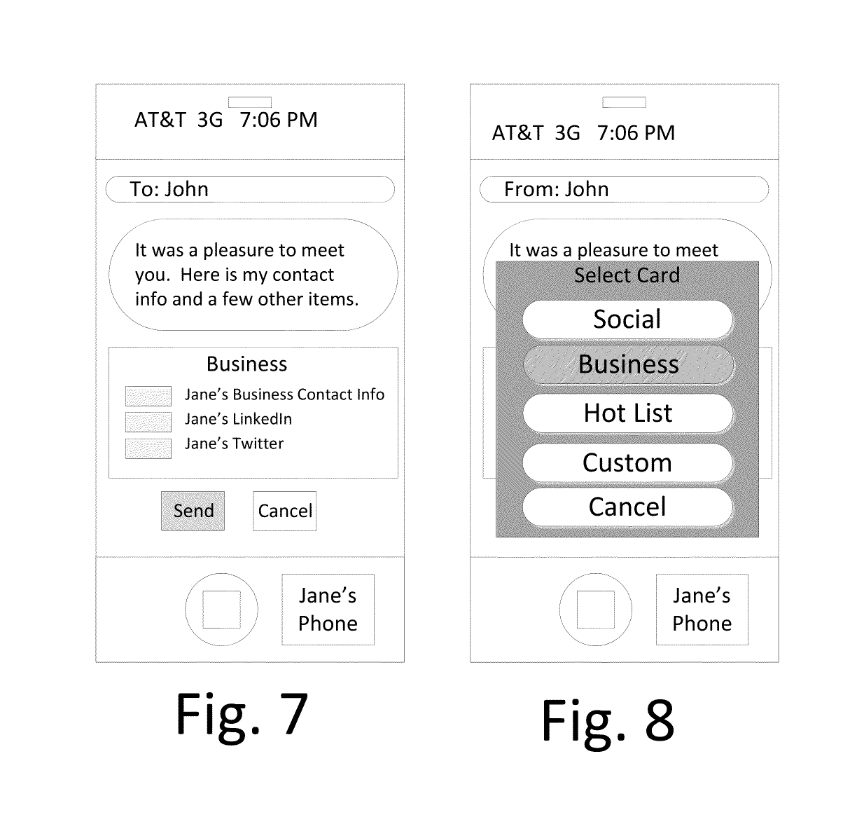

As illustrated in FIG. 5, the second individual's device 135 notifies her that as a result of the scan of her phone the first individual has sent her some information. By selecting the message, her device 135 opens to the app 140, displays the message and asks if she would like to respond as illustrated in FIG. 6. Selecting “Respond” means that she is taking immediate action. Selecting “Ok” holds the information for later processing in the app history. The second individual 125 can manage the engagement later through her mobile device or a web-based application. If the second individual 125 selects to “Respond,” the app presents her default sharing preference as illustrated in FIG. 7. If the second individual 125 selects “Send,” the app 140 immediately transmits a message including the information he has chosen to share to the processing software 115.

As illustrated in FIG. 8, if the second individual 125 chooses to change her default message, she can choose from her other preset categories or create a custom message.

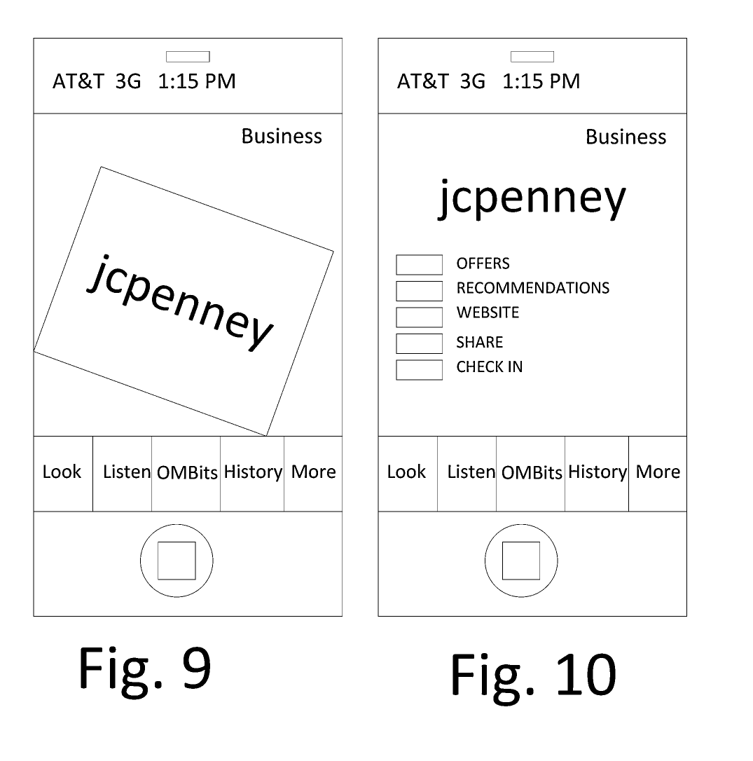

FIGS. 9-11 illustrate a business sharing digital information between individuals and businesses according to embodiments of the invention. The individual 120 enters a store, opens his app 140, and scans the store's individual digital watermark 1155 displayed on a logo sticker that is at the door, on or near a cash register 1180, or is broadcast in the store's background music. The store and the individual 120 are notified of a successful scan and are able to share information. The store and the individual 120 engage based on their preferences stored in the database 110. For example, the processing software 115 may transmit a coupon targeted specifically to the individual prompting him to shop for a certain item. The individual 120 can decide to continue or conclude the engagement at any time.

In FIG. 12, two individuals 120, 125 turn on their mobile devices 130, 135 to activate the wallpaper images and allow an airline desk employee to scan their individual digital watermarks. The airline business provides the first individual 120 with a notification that his flight is on time, provides his gate information, and prompts the individual 120 to join its frequent flyer program. The airline business provides the second individual 125 with similar flight and gate information, but because the second individual 125 is an elite frequent flyer member according to her profile information stored in the database 110, she is, for example, prompted to respond for an immediate upgrade option according to her seat preferences. Both the first individual 120 and the second individual 125 can further manage the engagement with the airline by choosing to respond to the prompts immediately, at a later time, or not at all.

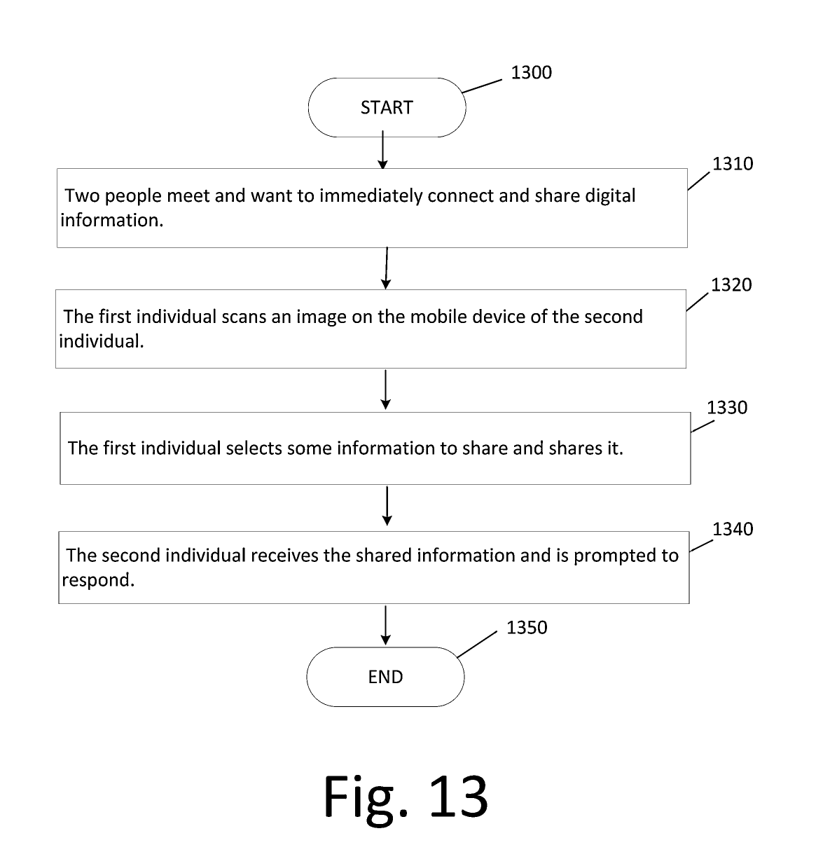

FIG. 13 illustrates the process of associating two individuals according to an embodiment of the invention. The process starts at step 1300. At step 1310, two people meet and want to immediately connect and share information. Then, at step 1320, the first entity 120 scans the image 150 on the second device 135 of the second entity 125. The image 150 contains the individual digital watermark 155. At step 1330, the first entity 120 selects some information and shares it. If this meeting is business related, the shared information may be professional in nature. Her business information may include her office phone number and a LinkedIn connection request. If this meeting is social, the first entity 120 may choose to reveal some personal information such as a cell or home phone and a Facebook friend request. At step 1340, the second entity 125 receives the shared information from the first entity 120 and is prompted to share in return. The process may be repeated recursively a number of times and ends at step 1350.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The apps 140 can be used to control preferences, profile data, privacy settings, and digital identities. Also, the following information can be controlled: contact information; medical/health information; demographic/psychographic information; login information; membership information; brand loyalty program information; files; photos; music/playlists; bookmarks; engagement preferences; deal site preferences; reviews; feedback; connection requests; invitations; social network information; communication interactions; websites; blogs; calendar information; home electronic information; card wallet information; call to action; check-in/location information.

Further, an individual allowing a business to scan his individual digital watermark may receive: information exchange requests; promotional opportunities; relationship building opportunities; marketing opportunities; consumer activity information; consumer location information; consumer feedback; verification/authentication of identity; efficient information exchange; controlled engagement; rewards points; upgrades; coupons; offers; deals; entertainment; and access.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A method for sharing digital information between two mobile devices, the method comprising the steps of:
acquiring, at a first mobile device, a sample of a communications media originating at a second mobile device;
processing, at the first mobile device, the sample to ascertain a unique digital watermark embedded within the communications media; and
attaining, at the first mobile device, a digital identity of a person associated with the ascertained unique digital watermark.

2. The method of claim 1, wherein the step of acquiring further comprises the steps of:
executing a software application on the first mobile device;
instructing, via the software application, a data acquisition component of the first mobile device to capture the sample; and
storing the sample in memory.

3. The method of claim 2, wherein the data acquisition component comprises a camera, the communications media comprises an image being displayed on the second mobile device, and the sample comprises a digital image captured by the camera of the image being displayed on the second mobile device.

4. The method of claim 2, wherein the data acquisition component comprises a microphone, the communications media comprises an audio file being played on the second mobile device, and the sample comprises a digital audio recording captured by the microphone of the audio file being played on the second mobile device.

5. The method of claim 2, wherein the data acquisition component comprises a video camera, the communications media comprises a video file being displayed on the second mobile device, and the sample comprises a digital video recording captured by the video camera of the video file being played on the second mobile device.

6. The method of claim 2, wherein the software application performs the step of processing, at the first mobile device, the sample to ascertain a unique digital watermark embedded within the communications media.

7. The method of claim 1, wherein the step of processing, at the first mobile device, the sample to ascertain a unique digital watermark embedded within the communications media further comprises the step of detecting information carried by the unique digital watermark.

8. The method of claim 7, wherein the step of attaining, at the first mobile device, a digital identity of a person associated with the ascertained unique digital watermark further comprises the steps of:
transmitting, from the first mobile device, the detected information a digital identity of a person associated with the ascertained unique digital watermark carried by the unique digital watermark to a remote server; and
receiving, at the first mobile device, the digital identity or a link to the digital identity stored on a remote server.

9. A method for disseminating digital identities associated with users of mobile devices, the method comprising the steps of:
storing, at a computer server, a plurality of digital identities, wherein each digital identity is associated with a user of a mobile device and is identified by a unique identification;
generating, at the computer server, a communications media for a user of a first mobile device, wherein the communications media comprises a digital watermark storing a unique identification associated with the user of the first mobile device;
receiving, at the computer server, a request for a digital identity from a second mobile device, wherein the request comprises the unique identification associated with the user of the first mobile device;
identifying a digital identity associated with the user of the first mobile device; and
permitting said second mobile device to access the digital identity associated with the user of the first mobile device.

10. A system comprising:
a scanner on a first device belonging to a first entity;
a database configured to store digital information of a second entity having a second device; and
processing software configured to uniquely assign an individual digital watermark to the second entity having the second device, wherein the first device scans the individual digital watermark of the second device to unlock the stored digital information.

11. The system of claim 10, wherein the stored digital information is preselected into categories.

12. The system of claim 10, wherein the first device scans the individual digital watermark while not connected to a cellular network.

13. The system of claim 10, wherein the first entity is an individual or business.

14. The system of claim 10, wherein the first entity and the second entity are individuals.

15. The system of claim 10, wherein individual digital watermark is in an image, song, or video.

16. The system of claim 10, wherein individual digital watermark is invisible.

17. The system of claim 10, wherein the database comprises a profile and preferences.

18. The system of claim 10, wherein the processing software creates and embeds the individual digital watermark.

19. The system of claim 10, wherein the scanner is a camera.

20. The system of claim 10, wherein the scanner is a microphone.
